(19) United States
(12) Patent Application Publication
(10) Pub. No.: US 2007/0088652 A1
(43) Pub. Date: Apr. 19, 2007

(54) APPARATUS, SYSTEM, AND METHOD FOR INTERNET TRADE

(76) Inventors: Jonathan D. Firmage, Holiday, UT (US); Miles D. Romney, Los Angeles, CA (US); Joshua B. Higginbotham, Salt Lake City, UT (US); Jeffrey J. Thomson, Murray, UT (US)

Correspondence Address: KUNZLER & ASSOCIATES, 8 EAST BROADWAY, SUITE 600, SALT LAKE CITY, UT, 84111, US

(21) Appl. No.: 11/278,082

(22) Filed: Mar. 30, 2006

Related U.S. Application Data
(60) Provisional application No. 60/666,384, filed on Mar. 30, 2005.

(51) Int. Cl. G06Q 40/00

(52) U.S. Cl. 705/37; 705/35

(57) ABSTRACT

An apparatus, system, and method are disclosed for facilitating internet trading by combining trading network information and social network information. The apparatus may determine a search parameter and a level of degree of contact between a searcher and members associated with a social network. The level of degree of contract defines a number of degrees of separation between the searcher and seller within the social network. A search module may limit the search, or filter the results, to goods and services offered by members of the social network having a relationship within the level of degree of contact to the searcher. A matching module may perform n-way cross matching of items on one or more lists of goods and services offered and items on one or more lists of goods and services desired where n is an integer equal to, or greater than, two. A notification module configured to present the results of a search to the searcher.

### CROSS-REFERENCES TO RELATED APPLICATIONS

This application claims the benefit of U.S. Provisional Patent Application No. 60/666,384 entitled “Apparatus, System, and Method for Internet Trade” and filed on Mar. 30, 2005 for Jonathan D. Firmage, et al., which is incorporated herein by reference.

### BACKGROUND OF THE INVENTION

1. Field of the Invention

This invention relates to selling and trading goods and services over the internet and more particularly relates to selling and trading goods and services over the internet to a user defined group of other users.

2. Description of the Related Art

The advent of the internet provided consumers with a new marketplace in which to sell goods and services. In particular, the internet has provided a forum where users can sell new as well as used goods to one another, even when the buyer and seller reside thousands of miles apart. Unfortunately, these types of marketplaces have also made it much easier for the dishonest to employ fraud and deceit against unwary internet consumers.

One of the problems with internet trade is that many times a user does not know who the person is that they are dealing with. Often times, users represent themselves only by their username, thereby providing a cloak of anonymity to the honest and dishonest alike. The result of this in many cases is reluctance on the part of consumers to buy and sell products over the internet.

An additional problem with internet trade is created when users are both sellers and buyers. In such a situation, two or more users may each be selling a good or service that the other user is looking to purchase. Conventional internet trading sites currently require a buyer to search for or browse for items they wish to purchase, and lack the capacity to match up buyers with sellers and vice versa that may be selling or seeking reciprocal goods or services.

Besides commerce, the internet has also provided users with a forum in which to meet other users. Many internet sites now provide chat-rooms, instant messaging, blogs, and posting sites where internet users form virtual communities with one another. Although the users many times prefer to maintain anonymity, the virtual communities allow the various users to build up trust through their communications. Thus far, conventional internet trading sites have failed take advantage of the trust that exists within online communities to provide a marketplace where users are more comfortable transacting with one another because of the trust they have created.

From the foregoing discussion, it should be apparent that a need exists for an apparatus, system, and method that provides internet trading based on social relationships such that users may trade exclusively with those users that they reasonably trust. Furthermore, a need exists for an internet trading site that proactively matches buyers with sellers such that the users may more efficiently complete their transactions. Beneficially, such an apparatus, system, and method would allow for a more reliable marketplace and would minimize the number of instances of fraud on the internet. Furthermore, such an apparatus, system, and method would provide a marketplace where online communities can gather to buy and sell goods and services to those with whom they have established a relationship. Additionally, this type of marketplace may match those who are looking for particular goods and services with those who are selling the same goods and services.

### SUMMARY OF THE INVENTION

The present invention has been developed in response to the present state of the art, and in particular, in response to the problems and needs in the art that have not yet been fully solved by currently available electronic trading services. Accordingly, the present invention has been developed to provide an apparatus, system, and method for internet trading that overcomes many or all of the above-discussed shortcomings in the art.

The apparatus to perform electronic trading is provided with a logic unit containing a plurality of modules configured to functionally execute the necessary steps electronic trading. These modules in the described embodiments include a criteria module, a search module, a matching module, a notification module, a negotiation module, and a definition module, a data management module, a financial module, and a feedback module.

The criteria module, in one embodiment, is configured to determine a search parameter and a level of degree of contact between a searcher and members associated with a repository of social relationships. In a further embodiment the criteria module is configured to determine a user defined contact pool. In one embodiment, the degree of contact comprises a relationship between a member of a first contact pool and a member of a second contact pool, the level of degree of contract defining a number of degrees of separation between the searcher and seller, wherein the search module limits searches for goods and services offered to one or more members of the repository of social relationships having a relationship within the level of degree of contact. In one embodiment, the search parameter may include a price, a geographic location, or a product description. The search module, in one embodiment, is configured to search a repository of goods or services offered and a repository of social relationships based on a search parameter and a level of degree of contact between a searcher and members of the repository of social relationships. Furthermore, the search module may search a repository of goods based on a user defined contact pool. The repository of goods or services offered preferably relates the goods or services offered to members of the repository of social relationships such that each good or service offered has a corresponding member within the repository of social relationships. The search module in one embodiment determines whether goods or services offered satisfy the search parameter and the level of degree of contact.

The matching module, in one embodiment, is configured to perform n-way cross matching of repository content including cross-matching of items on one or more lists of goods and services offered and items on one or more lists of goods and services desired where n is an integer equal to, or greater than, two. Cross-matching of items on a list saves a user from having to repeatedly enter keywords defining or describing the item of interest. The have list and want list facilitate identifying what the user would be willing to include in a trade. The matching module in certain embodiments may expand items listed in the have list or want list to a set of similar terms or terms that describe the item in commonly used descriptive terms. This expanded set may be generated using existing dictionaries, thesauruses, or knowledge bases.

In one embodiment, the matching module is further configured to automatically perform the n-way cross matching of items within one or more lists of goods and services offered and items within one or more lists of goods and services desired. The proactive search and/or match capability of the present invention may be controlled by a user setting. The user setting may define the period for running searches and/or matches or other conditions for when automatic matching should be conducted. For example, each time a new item of a particular type, category or keyword set is added to the goods and services repository the matching module and/or searching module may automatically begin comparing a users have list and want list to the newly added items to identify possible matches.

In another embodiment, the matching module may be configured to match only a portion of a list of goods and services, and in an alternate embodiment, the matching module may be further configured to match an entire list of goods and services.

The notification module, in one embodiment, is configured to present the results of a search to the searcher. In a further embodiment, the notification may present the results of the matching to a user or searcher. In one embodiment, the notification module is further configured to automatically present results of the searching or matching to a user in response to the matching module finding a new match. In another embodiment, a user may enter a freeform keyword or keywords to be immediately matched against the system's have and/or want lists.

The negotiation module, in one embodiment, is configured to enable electronic transaction negotiations between two or more users, the electronic transaction negotiations comprising communicating offers and counteroffers between two or more users.

The definition module, in one embodiment, is configured to define related goods or services according to predefined features.

The data management module, in one embodiment, is configured to modify the repository of goods or services offered and the repository of social relationships based on user input.

The financial module, in one embodiment, is configured to enable electronic financial transactions associated with trading or selling the goods or services offered.

The feedback module, in one embodiment, is configured to record and communicate the success or failure of a trading experience between two transacting parties.

A method of the present invention is also presented for performing electronic trading. The method in the disclosed embodiments substantially includes the steps necessary to carry out the functions presented above with respect to the operation of the described apparatus and system. In one embodiment, the method includes the steps of: determining a search parameter and a level of degree of contact between a searcher and members associated with a repository of social relationships; search a repository of goods or services offered, a repository of goods or services sought, and the repository of social relationships based on a search parameter and a level of degree of contact; performing n-way cross matching of repository content including cross-matching of items on one or more lists of goods and services offered and items on one or more lists of goods and services desired where n is an integer equal to, or greater than, two; and present the results of the matching to a user.

In one embodiment, the method includes defining a user contact pool for managing which other users are able see the primary users listings. The method also may include establishing a voucher system in which one user vouches as to the trustworthiness of another user such that other users may rely on the vouchers to determine the trustworthiness of various users. In a further embodiment, the method may include tracking a genealogy of degrees of contact between users such that a user may specify a degree of contact within which the user is willing to trust other users.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for internet transactions;

FIG. 2 is a schematic block diagram illustrating one embodiment of an apparatus for internet transactions;

FIG. 3 is a schematic block diagram illustrating one embodiment of a definition module;

FIG. 4 is a schematic flow chart diagram illustrating one embodiment of a method for performing n-way matches.

FIG. 5 is a schematic block diagram illustrating one embodiment of a partner inventory trade module;

FIG. 6 is a schematic block diagram illustrating one embodiment of a financial module;

FIG. 7 is a schematic flow chart diagram illustrating one embodiment of a method for internet transactions;

FIG. 8 is a process flow chart diagram illustrating one embodiment of an internet transaction process flow; and

FIG. 9 is a schematic block diagram illustrating one embodiment of a system repository that includes user data, user trade listing data, and user social relationship data for use by one embodiment of the present invention.

### DETAILED DESCRIPTION

The embodiment as illustrated is an electronically enabled, Internet accessible marketplace for cash, cash-supplemented, and cashless transactions, providing listing and matching of users' “haves” and “wants.” A “have” is defined as an item or service that a user has to offer. A “want” is defined as an item or service that a user wants to obtain.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Unless otherwise indicated, a module may comprise a commercially available computer program or specially designed computer software and hardware such as are known in the art. An example of an appropriate programming language includes “PHP” hypertext pre-processor, which could also be described as a “programming language” or a “scripting language” (Copyright 2001-2005 The PHP Group.)

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

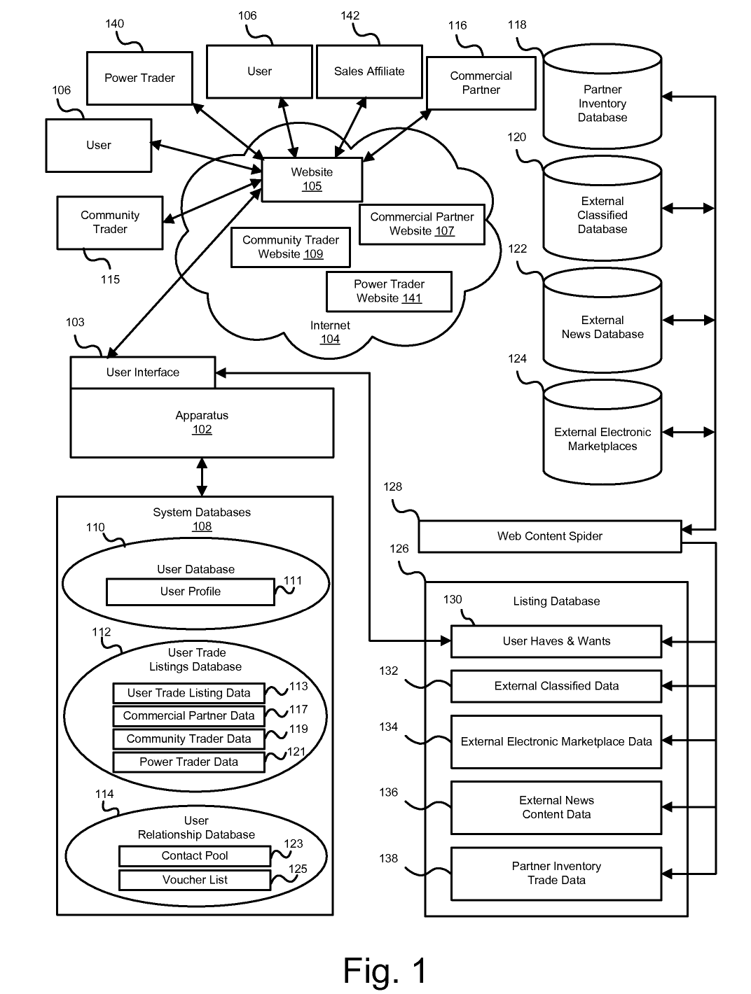

FIG. 1 is a schematic block diagram illustrating one embodiment of an internet transaction system 100, situated in an environment that includes the internet 104, users 106, external classified databases 120, online news sites 122, and electronic marketplaces 124. As depicted, the system 100 includes a trade apparatus 102, a user interface 103, a website 105, system databases 108, listing databases 126, and a web content spider 128.

In certain embodiments the internet trade system 100 may also include a commercial partner 116, a commercial partner website 107, a community trader 115, a community trader website 109, a power trader 140, a power trader website 141, and a sales affiliate 142, a commercial partner 116 may be a brick and mortar establishment participating in the system 100 through the partner inventory database 118. A community trader 115 may be an entity supplying a website focusing on a particular interest, area of expertise, location, or audience. A power trader 140 may be an individual or organization who has purchased a customized storefront featuring their own listings. A sales affiliate 142 may be an entity that has purchased the right to participate in revenue sharing by referring members to the system.

The system databases 108 include a user database 110, a user trade listings database 112, and a user relationship database 114. The user trade listing database 112 may include a user trade listing data 113, a commercial partner trade listing database 117, a community trader trade listing database 119, and a power trader listing database 121. The user relationship database 114 may include a contact pool 123 and a voucher list 125. The listing database 126 includes user haves and wants 130, external classified data 132, external electronic marketplace data 134, external news content data 136, and partner inventory trade data 138.

In one embodiment, a user 106 accessing the website 105 is invited to concurrently list a specified number of haves and wants. An incremental cost may apply to the listing of increasingly greater numbers of concurrent haves. The user's 106 have and want lists may be entered into the user trade listing database 112 according to a category or other unique identifier. A further embodiment allows the user 106 to search the user trade listing database 112 for other users' 106 haves and wants. The user 106 may select specific parameters for the search, thereby returning more viable trade possibilities. These parameters may include price, location, and the relationship between the user and the potential trade partner, as defined by the relational database 114.

In a further embodiment, the number of items listed may be determined for purposes of cost by the concurrent rather than the total number. For example, if a user 106 has listed five items and disposes of one, a new item may be added to the list at no extra cost to maintain the concurrent total at five throughout the billing period.

The web content spider 128 may search the partner inventory database 118, the external classified database 120, the external news database 122, and the external electronic marketplaces 124 for items matching categories and/or keywords defined in the system 100. For example, if the system categories and/or keywords includes flowers, bicycles, and cars, the web content spider would identify and capture database information referencing items within these categories and/or keywords.

The user interface 103 may populate the user haves and wants 130 within the listing database 126. The web content spider 128 may populate the external classified data 132, the external electronic marketplace data 134, the external news content data 136, and the partner inventory trade data 138 with the information gleaned in its search.

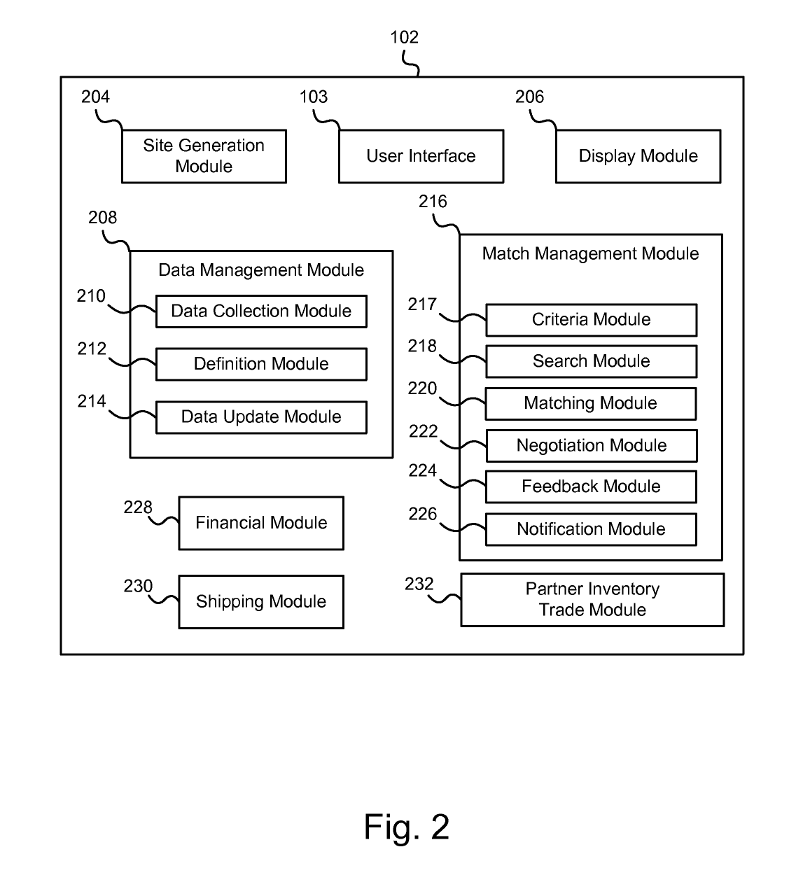

FIG. 2 is a schematic block diagram illustrating one embodiment of an internet transaction apparatus 102. As depicted, the apparatus 102 includes a user interface 103, a site generation module 204, and a display module 206. The apparatus 102 may also include a data management module 208, which includes a data collection module 210, a definition module 212, and a data update module 214. The apparatus 102 may further include a match management module 216, which includes a search module 218, a criteria module 217, a matching module 220, a negotiation module 222, a feedback module 224, and a notification module 226. A financial module 228, a shipping module 230, and a partner inventory trade module 232 may also be part of the apparatus 102.

The user interface module 103 provides communication between the user 106 and the apparatus 102 via the internet 104 or another communication channel. Such communication may be primarily through the display module 206 in connection with the system website 105. The site generation module 204 assists a commercial partner 116 or community trader 115 in customizing a website automatically generated in accordance with methods known in the art.

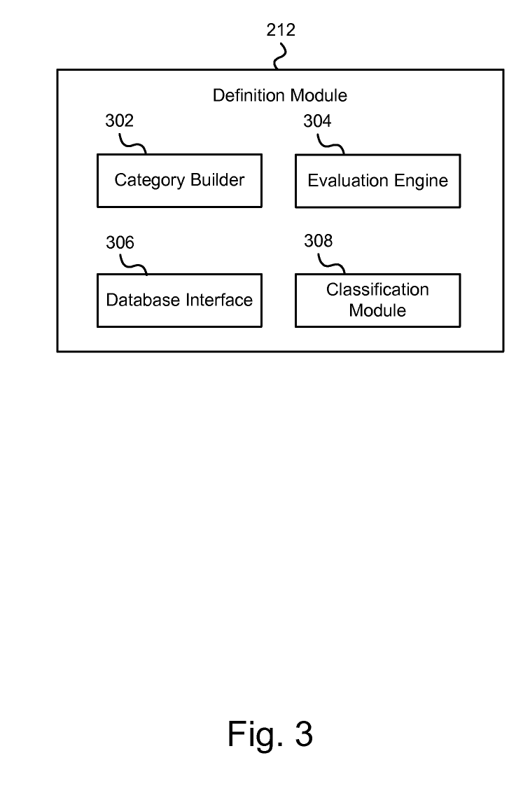

The data management module 208 collects and upgrades data via the data collection module 210 and the data upgrade module 214. The definition module 212 defines categories and classifies objects. One example of the definition module is shown in FIG. 3. The data collection module 210 may interact with the user interface 103, with the data update module 214, and with the various databases to collect and store data. The data update module 214 may interact with the match management module 216 and the databases to, for example, add a new item to the user trade listings database 112, add user information to the user database 110 and add user relationship data to the user relationship database 114. The data update module 214 may also remove a listing when an item is traded or sold and add, delete, or modify the user database 110, and the user relationship database 114 as appropriate.

In one embodiment, the match management module 216 includes the criteria module 217, the search module 218, the matching module 220, the negotiation module 222, the feedback module 224, and the notification module 226.

The criteria module 217 is configured to determine a search parameter and a level of degree of contact between a searcher and members associated with a repository of social relationships such as user relationship database 114. In a further embodiment, the criteria module 216 may be configured to determine the boundaries of a user defined group of contacts based on contact pool parameters. Furthermore, the criteria module 217 may be configured to determine a quantified level of trust between a user and those users defined within the contact pool and having the level of degree of contact. In one embodiment, the criteria module 217 is configured to provide search parameters as well as social contact limitations to the search module 218 and matching module 220.

The search module 218 is configured to search the system databases 108, the partner inventory database 118, the external classified database 120, the online news sites 122, the electronic marketplaces 124, and other databases for item information, personal information, and relationship information relevant to a match, sale, or trade. The search may be based on user input such as price, geographic location, item description, or social relationship. In one embodiment, the search is based on a search parameter and level of degree of contact between a searcher and members associated with a repository of social relationships. For example, the search module 218 may search for all automobile hood ornaments offered for trade, or for all users wanting a bicycle, or for all bicycles within a certain price range or location. As an additional example, the search module 218 may also search the user relationship database 114 for all users within a certain number of degrees of contact with respect to a specific user 106.

In one embodiment, the matching module 220 may perform matches on the search results. The matching module 220 may be configured to match entire or partial lists of items or services. The matching module 220 may be further configured to perform n-way direct and indirect matching, where n is a positive integer equal to or greater than two. For example, if John has a bicycle and wants a leaf blower, Mark wants a bicycle and has a television, and Sarah wants a television and has a leaf blower, the matching module 220 may identify that potential three-way trade between John, Mark, and Sarah. The matching module 220 may also perform a four-way, five-way, or n-way trade. In a further embodiment, the matching module may recognize a social relationship such as a specified level of degrees of contact as a necessary element of a match. The matching module may also include other factors such as price, location, and condition in the matching process.

The notification module 226 notifies the relevant parties of a potential trade via email, web notification, instant message, cellular phone text message or other means.

The negotiation module 222 enables negotiation between parties to trades, purchases, mixed trade and purchase, and other transactions. In doing so, the negotiation module 222 may interact with the matching module 220, the user interface 103, the display module 206, and the feedback module 224. The feedback module 224 may communicate offers and counteroffers to the negotiation module 222. When an agreement is reached, or is close enough that the parties signal a desire for direct communication, the notification module 226 may interact with the user database 110 and supply each party with contact information, such as an email address. Each party may specifically define what contact information will be shared with others, based on negotiation status, contact pool status including degrees of separation in the user relationship database 114, administrator status, and other relevant factors.

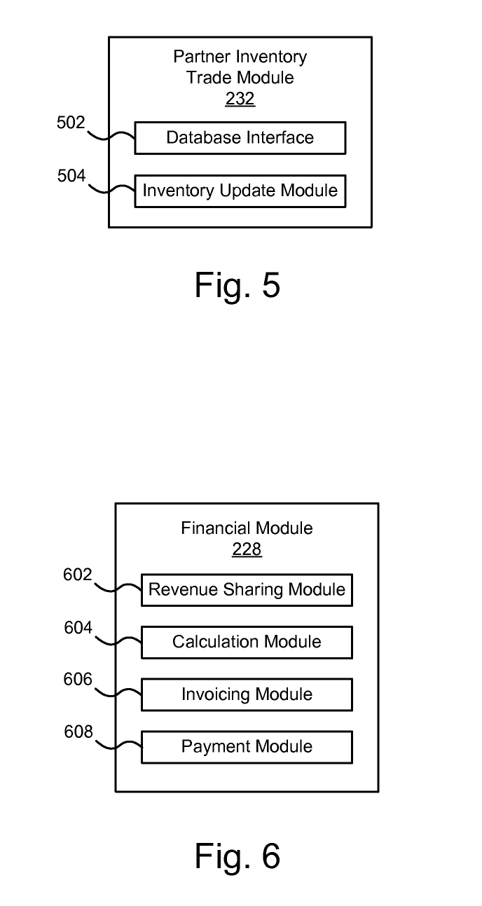

The financial module 228 is configured to perform system accounting functions. One example of the financial module 228 is shown in FIG. 6. The shipping module 230 is configured to prepare shipping labels for items. In an alternative embodiment, the partner inventory trade module 232 may also include dedicated matching, accounting, shipping and other modules. One example of the inventory trade module 232 is shown in FIG. 5.

The partner inventory trade module 232 is configured to manage trades into and out of the inventory of a commercial partner 116. For example, a music CD exchange enterprise may elect to put its inventory on a commercial partner website linked to the system website 105. In such a case, the search module 218 and matching module 220 would search and match CD's desired by a user 106 against the partner inventory database 118. The partner inventory trade module 232 might register the match, send a message to pull the match from inventory, generate labels to ship the match, and update the partner inventory database 118. The partner inventory trade module 232 may also generate a shipping label for the CD traded in by the user and add that CD to the partner inventory database 118. In a further embodiment, the partner inventory trade module 232 may perform associated accounting.

FIG. 3 is a schematic block diagram illustrating one embodiment of the definition module 212. The depicted definition module 212 includes a category builder module 302, a keyword evaluation module 304, a database interface 306, and a classification module 308. In one embodiment, the category builder 302 is configured to create a list of categories and establish the identifying features of each. The category building may be automatic or performed in cooperation with system personnel, a commercial partner 116, or a community trader 115. A commercial partner 116, or community trader 115 may be given authority to define and manage a “category tree,” which is a general primary category with branching sub-categories. The database interface 306 may interact with the various databases and also with the evaluation module 304 and the classification module 308 in order to assign each item and service to one or more of the defined categories.

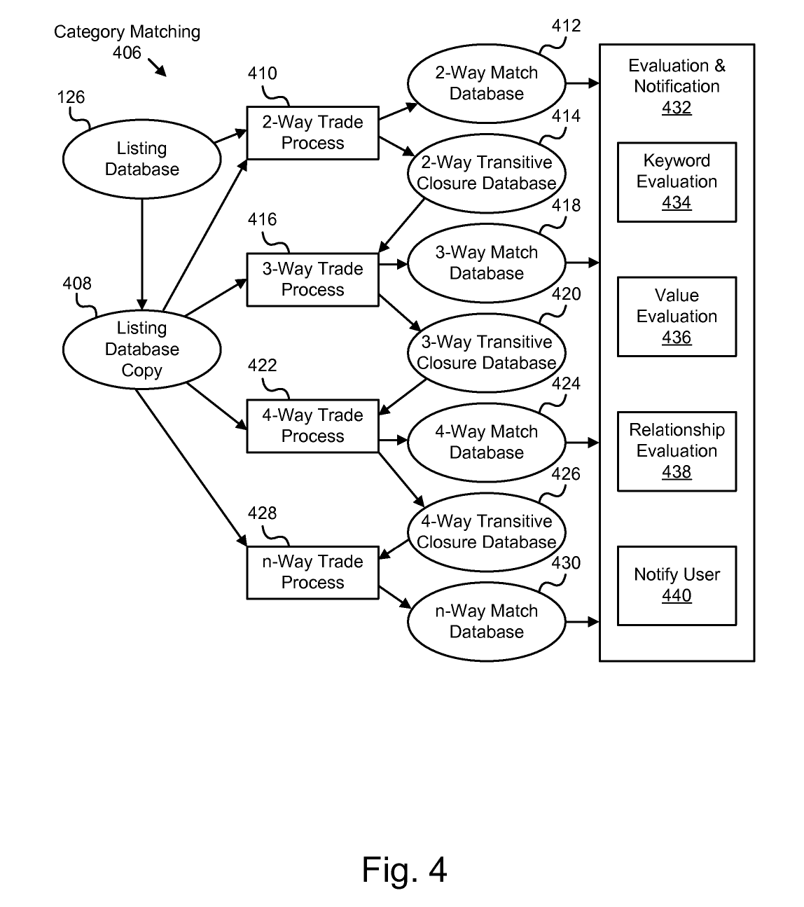

FIG. 4 is a schematic flow chart diagram illustrating one embodiment of a method 400 for performing n-way matches. In the depicted embodiment a two-way trade process 410 receives data from the listing database 126 and creates a 2-way match database 412. The 2-way match database 412 may be passed to a keyword evaluation module 434, a value evaluation module 436, and a relationship evaluation module 438. The keyword evaluation module 434 may evaluate matches of keywords. The value evaluation module 436 may evaluate correspondence of values. The relationship evaluation 438 may evaluate degrees of relationship relative to the degree specified. In one embodiment, the relationship evaluation 438 may categorize matches of relationships based on how many degrees of separation exist between the users involved in the match. For example, a user may specify a certain level of degree of contact such as three. In one embodiment, this may mean that searching or matching should include only those contacts within three degrees of separation from the user. So if user 1 has a contact called user 2, and user 2 has a contact called user 3 who is not a contact of user 1, then user 1 is two degrees of contact away from user 3. Therefore, the relationship evaluation 438 may categorize the matches based on levels of degrees of contact (i.e. levels 1, 2, 3, . . . n degrees of contact). The users 106 receive notification 440 of matches meeting keyword, value, and relationship specifications. Other parameters such as location may also be evaluated prior to notification 440.

The method 400 may include creation of a listing database copy 408, configured for ease of interaction in n-way trades. For example, the listing database copy may be configured to most efficiently evaluate a 2-way, 3-way, etc. trade. In one embodiment, in a 3-way trade, the 2-way trade process 410 may generate a 2-way transitive closure database 414 by creating a listing of the possible two-way matches. A transitive closure database 414-430 stores the listings of possible matches. A transitive closure database stores listing of matches between A and B and matches between B and C such that the present invention can determine that a match exists between A and C. The 3-way trade process 416 may match the 2-way transitive closure database 414 against the listing database copy 408 and create a 3-way match database 418 by comparing the possible two-way matches to a list of third possible matches. The 3-way match database 418 may be evaluated as described above, and the users 106 may be notified of successful 3-way matches.

The method 400 may proceed in an iterative fashion, with the 3-way trade process 416 passing a 3-way transitive closure database 420 to a 4-way trade process 422. The 4-way trade process 422 may match the 3-way transitive closure database 420 against the listing database copy 408 and create a 4-way match database 424. The 4-way match database 424 may then pass to evaluation and notification 432 and users may be notified 440 of successful matches.

The method 400 may continue through n steps, where n is a positive integer greater than 1. The n-way trade process 428 may match the previous transitive closure database against the listing database copy 408 and generate an n-way match database 430.

In an additional embodiment of method 400 for performing n-way matching, the steps are conducted proactively such that the method 400 continues to evaluate and notify a user of possible matches until a user provides input indicating otherwise. For example, a user may be searching for a particular item that does not exist in any of the system databases 108 or listing databases 126. As the databases 108 and 126 are updated the method 400 may continuously run until the sought after item shows up in one of the databases 108 and 126.

FIG. 5 is a schematic block diagram illustrating one embodiment of a partner inventory trade module 232. As depicted, the partner inventory trade module 232 includes a database interface 502 and an inventory update module 504. The database interface 502 accesses the partner inventory databases 118 and interacts with the matching module 216, which finds matches to want lists from the users 106. The inventory update module 504 removes sold and traded items from the partner inventory database 118 and adds items purchased and taken in on trade.

FIG. 6 is a schematic block diagram illustrating one embodiment of a financial module 228. In one embodiment, the financial module 228 includes a revenue sharing module 602, a calculation module 604, an invoicing module 606 and a payment module 608. In certain embodiments the financial module 228 is configured to receive transaction information from other modules, including the match management module 216, the partner inventory trade module 232, and the shipping module 230, and to perform accounting functions relevant to each transaction. In various embodiments these functions may include tracking, invoicing, and distributing listing and other fees. The financial module 228 may also track and distribute commercial partner 116 and community trader 115 profit shares. Additionally, the financial module 228 may track and invoice sales and the cash portion of mixed cash and barter transactions, and perform general ledger functions.

The revenue sharing module 602 is configured to determine the amount of shared revenues for commercial partners 116, community traders 115, and other revenue sharing entities such as power traders 140 and sales affiliates 142. The calculation module 604 may receive revenue sharing protocols from the revenue sharing module 602 and calculate the amount of revenue owed. Similarly, the calculation module 604 may receive trade, purchase, and sale transaction information, and perform the relevant calculations. In each case the calculation module 604 may pass the results to the invoicing module 606 or the payment module 608. In one embodiment the invoicing module 606 is configured to invoice charges and the payment module 608 is configured to manage payments. In various embodiments the payment module 608 may order, track, generate and debit payments.

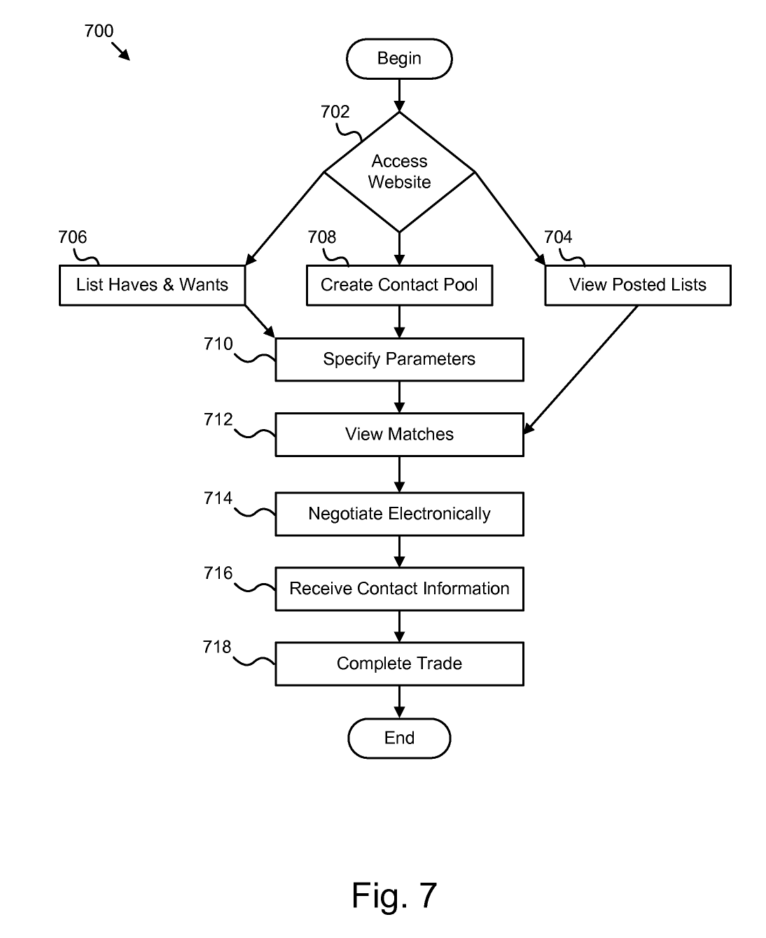

FIG. 7 is a schematic flow chart diagram illustrating one embodiment of a method 700 for a simple trade transaction that may be facilitated by the internet transaction system 100. As depicted, the method 700 includes the operations of accessing 702 the website 105, viewing 704 the posted lists, listing 706 haves and wants, creating 708 a contact pool 123 within the user relationship database 114, specifying 710 contact pool parameters 123 or list parameters, viewing 712 matches, negotiating 714 electronically, receiving 716 contact information, and completing 718 a trade or transaction. In various embodiments, the parameters may include price, condition, type, location, personal characteristics and degrees of contact. Two-way to n-way matches may be performed on single items, multiple items, or item lists. The trade may consist of an exchange of goods, services, or cash in any combination or proportion.

The user 106 may create the individual contact pool 123 by inviting and authorizing other selected users to participate in his/her pool and have access to his/her lists. A list typically includes at least one item or service listed as a want or have. In an alternate embodiment, a contact pool 123 may be updated automatically based on user preferences. For example, a user may include all users within a particular geographic region or within at least three degrees of contact with the user.

Members of a contact pool 140 may become part of a voucher system for each other. Traders unacquainted with a user 106 may access the user's voucher list 125. Positive vouchers predictably increase the new trader's level of confidence in the history and reputation of the user 106. In a further embodiment, a user 106 may post references on the website 105 that another user may review or contact before doing business with the referred user. In a further embodiment the voucher may comprise financial peer-rating, in which users with a history of transactions vouch for each other. In one embodiment, financial peer-rating includes rating another user after a transaction with them is completed. The user 106 may define listings to limit matches to other individuals with a specific level of peer-rating.

For example, if user 1 conducts a search and discovers a car that he/she is interested in purchasing from user 2, but user 1 isn't sure whether or not user 2 can be trusted, then user 1 may read financial peer ratings from others that have conducted business with user 2. User 1 may simply rely on a voucher indicator such as a number of stars, a value, or the like. These other users and user 2 may be many degrees of contact removed from user 1. In another embodiment, user 1 may check for references posted about user 2, or user 1, in yet another embodiment, may simply rely on a specified level of degree of contact between user 1 and user 2. In yet another embodiment, user 1 may rely on a voucher from a known user that is willing to vouch for user 2's trustworthiness.

In a further embodiment of the method 700, the apparatus 102 creates a genealogy of “degrees” of contact based on contact pool 123 membership. A user 106 and a member of the user's contact pool 123 are first degree contacts. Members of the contact pool 123 of the individual who is a member of the user's 106 contact pool 123, but who are not themselves members of the user's 106 own contact pool 123 would be the user's 106 second degree contacts and so forth. In addition to performing location oriented hierarchical searches, a further embodiment may perform searches based on a hierarchy of degrees of contact. A further embodiment may present the contact genealogy with the match results. The user 106 may restrict a search to specified degrees of contact or restrict individual listings in his haves or wants list to a specific number of degrees of contact. For example, a teenage girl may wish to offer babysitting services only to people within two degrees of contact (someone who knows someone who the teenage girl knows).

A further embodiment of the method 700 extends the function of the location oriented hierarchy and contact pool 123 to include borrowing and/or renting of items. Borrowing or renting options may favor or be restricted to locations within a certain distance of the user 106 or/and to members of the user's 106 contact pool 123. A further embodiment may restrict borrowing or renting to a specified geographical proximity. In a further embodiment the website provider or an associated entity may act as a broker.

In addition, non-reciprocal matches may be found using the have and want lists of users 106 as well as third-party content from external classified databases 120 and other sources gathered by the web content spider 128. If, for example, Bob had defined “Lawn Care” as a want, and McCarn Lawn Care had defined “Lawn Care” as a have, Bob and McCarn Lawn care would be notified that a possible for-cash transaction had been found. Alternatively, if Jones Lawn Care had posted a classified advertisement on a third-party classified system that was gathered by the web content spider 128 into the external classified database 120, Bob would be notified that an outside match had been found. Additionally, items may be matched with whole or partial cash payments.

The method 700 may also provide for commercial partners 116. These might typically be brick and mortar establishments that list their inventory on the partner inventory databases 118. For example, a music compact disk (“CD”) trading enterprise might list its inventory on the partner inventory database 118. In such a case, users could have access to the entire inventory or any determined subset. The apparatus 102 may compare the CDs in the users have and want lists with the inventory database 118 and notify the user 106 of a match.

A further embodiment of the method 700 may flag the desired CD from inventory database 118. A mailing label for the inventory CD may be printed. A mailing label addressed to the CD store may also be sent to the website user 106.

A user 106 employing the method 700 might qualify as a community trader 115 and create a community trader website 109 focusing on a specialty area of interest, for example antique cars. A commercial partner 116 may create a commercial partner website 107 and have the ability to maintain private-labeled marketplaces, sharing partner inventory trade listing data 117 with all other commercial partners 116. In certain embodiments community traders 115 may share community trade listing data 119. Those selected as “authoritative” in any particular niche may be granted access to define and maintain a branch of the overall trade category tree.

Visitors to a commercial partner site 117 or community trader site 119 would be most likely to list haves and wants in the focus space, but these would be linked via the apparatus 102 to the system databases 108 and to additional databases 112, 118, 120, 122, and 124. Therefore, a visitor to, for example, an antique car site wanting to trade expertise in restoring leather upholstery for a 1979 Packard hood ornament could be introduced via email to a website 105 user 106 wanting upholstery help or having the hood ornament to trade. In one embodiment an always-on proactive matching module 404 constantly searches for matches, and informs the relevant users 106 via e-mail or other means when a match is found. In one embodiment, the users may communicate only by way of the website 105 or other anonymous communications system so as to protect identity and ensure valid transactions.

A further embodiment of the method 700 may provide commercial partners 116 with an automatically generated website 107 and community traders 115 with an automatically generated community trader website 109. The system website 105 may supply tools and instructions for customizing websites for a commercial partner 116 or community trader 115. Commercial partners 116 and community traders 115 might participate in revenue sharing. For example, a commercial partner 116 and a community trader 115 may receive a percentage of the listing fees of new users that join the network through the websites of the commercial partner 116 and the community trader 115. Likewise, a power trader and sales affiliate may receive such revenue sharing. A power trader may be a user 106 who purchases a power trader site in a given period and a sales affiliate may be a user 106 who signs up a certain number of new users within a given period.

In a further embodiment the method 700 may provide automatic revenue sharing. The apparatus 102 may access the system databases 108, partner inventory databases 118, and external classified databases 120 and automatically perform customer interface, data collection, matching, searching, negotiation, feedback, notification, updating, accounting, and shipping operations.

In a further embodiment of the method 700 the search may extend beyond the database 112 to outside sources including external classified databases 120, online news sites 122, and other electronic marketplaces 124 listing items or services for sale. In addition, the apparatus 102 may cross-match the user's entire list of haves with the wants lists in the database 112 and cross match the user's entire list of wants with the haves lists in the database 112. By cross-matching an entire list, the apparatus 102 enables the users to possibly find the most equitable deal possible. The apparatus 102 may additionally perform two-way, three-way and greater multi-dimensional searches.

A further embodiment may include a defined generic search. For example, a search may be made for everyone who wants a bicycle in a specific geographic location, or everyone who has a lawn mower in a specific price range, or everyone who has a piano within a certain location and price range, or everyone within a certain location who has a violin within a specified price range and wants a harp within a specified price range. In all of the above embodiments the results may return all or any subset of matches found.

The method 700 may also create a confidentially maintained user profile 111, including location information in the user database 110. Searches may be conducted and multiple matches presented in a location oriented hierarchy, beginning with the match located geographically closest to the user. This facilitates trading of large items and also enables trades of services as well as goods. In a further embodiment, users 106 negotiating for a trade may view all of the other user's 106 have and want lists, opening up trade opportunities for items on the viewed lists that the user has, or wants, but has neglected to list. Users 106 may at their own election use cash as part or all of the payment for an item or service. Any party may submit a counter offer.

In a further embodiment, the user 106 is identified on the website 105 only by a selected user name, “handle,” or “screen name.” All personal information is kept confidential in the secure user database 110 and may be encrypted. When the user 106 identifies a potentially satisfactory match, the apparatus 102 may provide the user and the party providing the match each with the other's email address. The remainder of the transaction may then be conducted between the parties themselves or their designated agents.

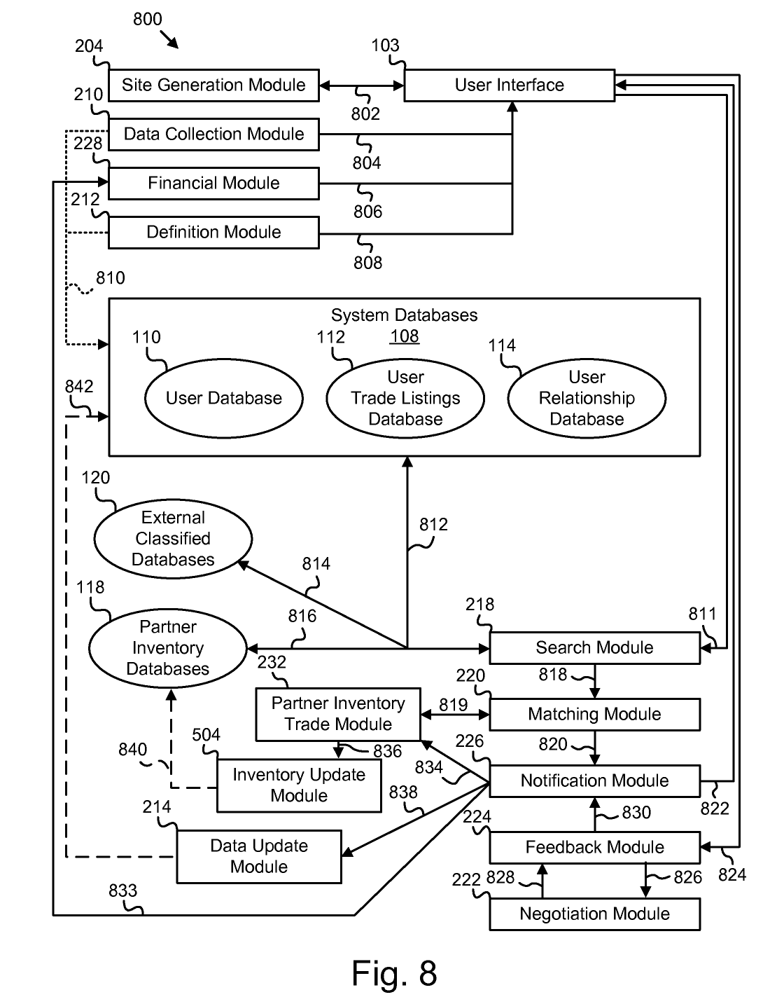

FIG. 8 is a schematic process flow diagram illustrating one embodiment of a process flow 800. The solid lines indicate interactive communication such as queries and responses. The dotted lines indicate data flow.

As depicted, the process flow 800 includes interaction 802 between the user interface 103 and the site generation module 204 and interaction 804 between the user interface 103 and the data collection module 210. The interaction 802 supplies the user interface 103 with the system website 105, and may also create customized sites 107, 109, and 142 for commercial partners 116, community traders 115, and power traders 140. The interaction 804 may collect have and want lists, item data, service data, personal data and buddy data or contact pool data. All private data may be maintained in a secure or encrypted form during transmission and storage.

The process flow 800 also includes interaction 806 between the user interface 103 and the financial module 228. The interaction 806 may supply the financial module 228 with account and transaction information and allow the user 106 to interactively view relevant information and calculations. Interaction 808 between the user interface 103 and the definition module 212 provides the definition module 212 with information pertinent to definition and classification such as search parameters for classifying a particular group of related goods. The interaction 808 may also allow authorized users such as commercial partners 116 and community traders 115 to define a specialized category. The data flow 810 uploads into the system databases 108 the data collected from the data collection module 210, the financial module 228, the definition module 212, and the user interface 103.

Interaction 811 between the user interface 103 and the search module 218 may initiate a search. In further embodiments information in the various databases may trigger a search, or the search module 218 and the matching module 220 may operate in an “always on” mode, constantly scanning the listing databases 126 and the user trade listing database 112 for matches. In interactions 812, 814, and 816 the search module 218 searches the system databases 108, the external classified databases 120 and the partner inventory databases 118. An input 818 supplies search results from the search module 218 to the matching module 220. The matching module 220 may perform two-way, n-way, single item, or list matches on the data from the input 818. In interaction 819 the matching module 220 alerts the partner inventory trade module 232 of a match. When a potential match is identified an input 820 informs the notification module 226. The notification 822 module notifies the user interface 103 of the match.

Response 824 from the user interface 103 to the feedback module 224 triggers negations through a negotiation feedback loop in which the feedback module 224 alerts 826 the negotiation module 222 which compares offers and returns 828 the comparisons to the feedback module 224. Interaction 830 passes these results to the notification module 226 which again notifies 822 the user interface 103. The resulting negotiation feedback loop 826, 828, 830, 822, 824, may continue until the parties reach agreement or abandon the negotiations.

Upon attainment of an agreement the notification module 226 notifies 822 the user interface 103 and may also notify 838 the data update module 214, notify 833 the financial module 228. Upon receiving notification 833 of an agreement, the financial module 228 may update accounts, calculate revenue sharing, create invoices and trigger shipping.

If the search module 218 discovers a desired item in the partner inventory databases 118 and the matching module 220 identifies a potential match for the item, then the matching module 220 interacts 819 with the partner inventory trade module 232 and information on the inventory item enters the feedback loop. In the event of notification 834 of a match, the partner inventory trade module 232 notifies 836 the inventory update module 504 which updates 840 the partner inventory databases 118. Notification 838 from the notification module 226 to the data update module 214 triggers dataflow 842 from the data update module 214 to the system databases 108.

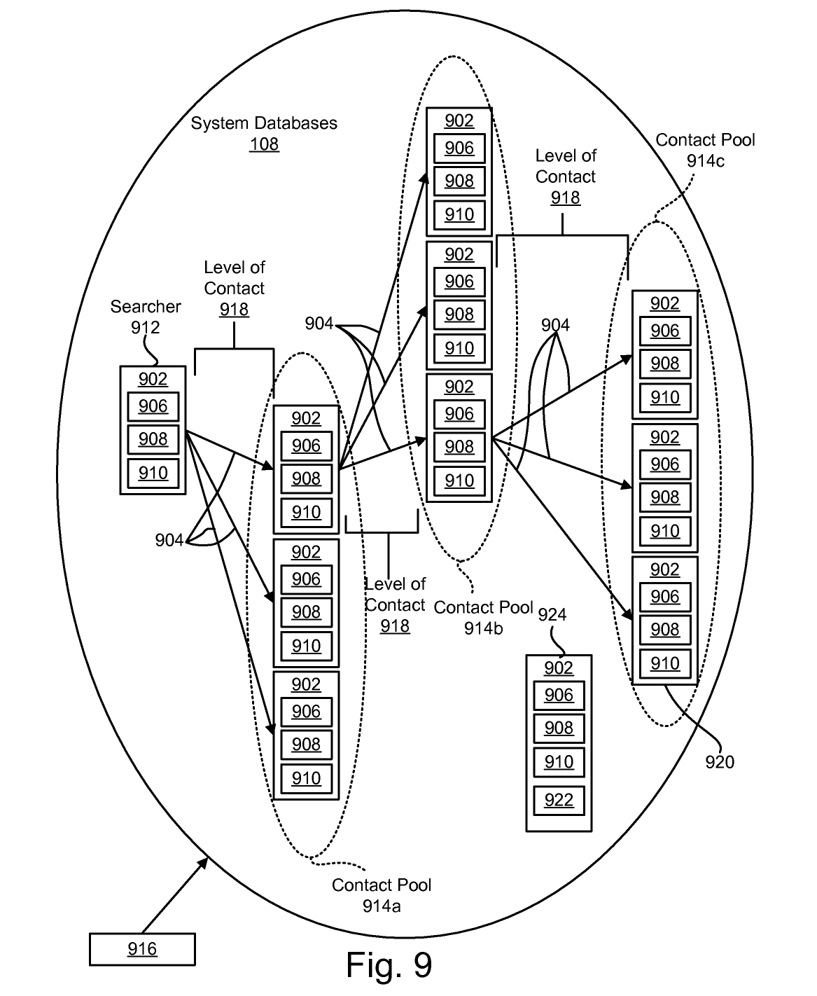

FIG. 9 is a schematic block diagram illustrating one embodiment of a system repository 108 that includes user data 110, user trade listing data 112, and user social relationship data 114 for use by one embodiment of the present invention. Those of skill in the art will recognize that the data of the system repository 108 may reside in one or more records, tables, databases, or database system locally stored or stored remotely in a distributed configuration. For clarity, FIG. 9 illustrates an embodiment of the system repository 108 in which user data, user trade listing data (one or more goods or services either offered for sale or trade or desired for purchase or trade), and social relationship data are represented within the same network of related members. Again, this is one or many implementations those of skill in the art may use to relate the user data, user trade listing data, and social relationship data.

FIG. 9 provides a logical view of the data elements and the relationships between them. Specifically, FIG. 9 includes a plurality of member nodes 902 interconnected by relationships 904 represented by arrows 904. The relationships 904 are may be created or removed by a user using a web interface. Each relationship 904 may represent a social relationship between the two users. The relationship 904 may related to a social relationship, a business relationship, or a combination of these. The users may represent a single person or an entity such as a business.

Member nodes 902 comprise data and information relating to a particular user. The member node 902 may include user data 906, one or more user have lists 908, and one or more user want lists 910. The user data 906 may include specific information about a user that is shared in the social network. Demographic information, contact information, and the like may comprise the user data 906. The user have lists 908 comprise one or more goods or services that a user has but is willing to trade or sell if the right offer is proposed. The user want lists 910 comprise one or more goods or services that a desires to obtain if the right offer is proposed.

A single member node 902 may be related to one or more other member nodes 902 by the relationship 904. The relationship 904 may be unidirectional or bidirectional. Establishing the relationship may be done based on user preferences set in the user data 906 or based on a request by a first user and grant of permission by a second user.

In one embodiment, the member nodes 902 having at least a unidirectional relationship to the searcher 912 may define a contact pool 914. Members 902 of the contact pool 914 are those with whom the user has a relationship 904. Because the user has some say in the establishing of the relationship 904, there exists a certain level of trust between the searcher 912 and members of the contact pool 914. Members within a first contact pool 914a may have their own contact pool 914b. Members of this second contact pool 914b may not necessarily be members of the first contact pool 914a. Similarly, members of the second contact pool 914b may have yet another contact pool 914c.

In one embodiment of the present invention, the system 916 searches for goods or services identified by criteria provided by the searcher 912 within the system data 108. The criteria may comprise one or more keywords or descriptions found within the searcher's want list 908. As explained above, the criteria for the search may include a defined level of contact 918.

Levels of contact 918 represent how many relationships 904 separate a searcher and another potential party to a sale or trade. The search module 218 may track levels of contact using contact pools or simply by tracing the number of relationships between a searcher and another member 902.

By way of example, suppose the searcher 912 initiates a keyword search for a desired item, a want, using a keyword description and within three levels of contact. The search module 218 would then search all members 902 separated from the searcher by three relationships 904 or less. If a member 920 is found with an item on the have list 908 that satisfies the keyword description, the searcher 912 receives search results indicating that a potential transaction could be completed with the member 920. The search results may also indicate that the member 920 is three levels of contact removed from the searcher 912.

In certain embodiments, the member node 902 includes a voucher indicator 922. The voucher 922 may comprise a star rating, a numeric value or any other indicator that represents confidence levels of those members 902 who have some sort of relationship, past or present, with the member 902. For example, member 924 may not be within the searcher's 912 contact pool 914 but searcher 912 may have taken a risk and completed a past transaction with the member 924. As a result, the searcher 912 may have provided a positive voucher indicator 922 for the member 924. This voucher indicator 922 may be used to by other members 902 to determine the trustworthiness of the member 924. The voucher indicator 922 may or may not identify the member 902 that created the voucher 922.

Thus, the present invention combines the social relationship information and the inherent trust in social relationships with the ability to trade and sell goods and services online to provide a more safe and secure marketplace. In addition, the present invention allows for automatic identification of potential transactions based on the have lists 908 and want lists 910. The member 902 can then approve, reject, or modify the potential transactions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to perform electronic trading, the apparatus comprising:
a repository of goods or services offered;
a repository of social relationships of members associated with the goods or services of the repository of goods or services offered;
a search module configured to search the repository of goods or services offered and the repository of social relationships based on a search parameter and a level of degree of contact between a searcher and a member of the repository of social relationships, the search module further configured to determine whether goods or services offered satisfy the search parameter and the level of degree of contact.

2. The apparatus of claim 1, wherein the repository of social relationships comprises a user defined contact pool.

3. The apparatus of claim 2, wherein the degree of contact comprises a relationship between a member of a first contact pool and a member of a second contact pool, the level of degree of contact defining a number of degrees of separation between the searcher and a seller, wherein the search module limits searches for goods and services offered to one or more members of the repository of social relationships having a relationship within the level of degree of contact.

4. The apparatus of claim 1, wherein the repository of social relationships further comprises a voucher system in which one user vouches as to the trustworthiness of another user.

5. The apparatus of claim 1, further comprising a negotiation module configured to enable electronic transaction negotiations between two or more users, the electronic transaction negotiations comprising communicating offers and counteroffers between two or more users.

6. The apparatus of claim 1, further comprising a definition module configured to categorize related goods or services according to predefined features.

7. An apparatus to perform electronic trading, the apparatus comprising:
a search module configured to search a repository of goods or services offered and a repository of social relationships based on a search parameter, the repository of social relationships comprising members offering goods or services in the repository of goods or services; and
a results module configured to evaluate results of the search based on a level of degree of contact between a searcher and members of the repository of social relationships.

8. An apparatus to perform electronic trading, the apparatus comprising:
a criteria module configured to determine a search parameter and a level of degree of contact between a searcher and members associated with a repository of social relationships;
a search module configured to search a repository of goods or services offered, a repository of goods or services sought, and the repository of social relationships based on a search parameter and a level of degree of contact;
a matching module configured to perform n-way cross matching of repository content including cross-matching of items on one or more lists of goods and services offered and items on one or more lists of goods and services desired where n is an integer equal to, or greater than, two; and
a notification module configured to present the results of the matching to a user.

9. The apparatus of claim 8, wherein the matching module is further configured to automatically perform n-way cross matching of items within one or more lists of goods and services offered and items within one or more lists of goods and services desired.

10. The apparatus of claim 9, wherein the notification module is further configured to automatically present the results of the matching to a user in response to the matching module finding a new match.

11. The apparatus of claim 8, wherein the matching module is further configured to match a portion of a list of the goods or services.

12. The apparatus of claim 8, wherein the matching module is further configured to match an entire list of the goods and services.

13. The apparatus of claim 8, wherein the search parameter comprises one of a price, a geographic location, and a product description.

14. The apparatus of claim 8, further comprising a data management module configured to modify the repository of goods or services offered and the repository of social relationships based on user input.

15. The apparatus of claim 8, wherein the repository of social relationships comprises a user defined contact pool.

16. The apparatus of claim 8, wherein the repository of social relationships further comprises a voucher system in which one user vouches as to the trustworthiness of another user.

17. The apparatus of claim 8, wherein the repository of social relationships further comprises a genealogy of degrees of contact.

18. The apparatus of claim 8, further comprising a financial module configured to enable electronic financial transactions associated with trading or selling the goods or services offered.

19. The apparatus of claim 8, further comprising a definition module configured to categorize related goods or services according to predefined features.

20. The apparatus of claim 8, further comprising a feedback module configured to communicate electronic offers and counteroffers between two or more users.

21. An apparatus to perform electronic trading, the apparatus comprising:
a search module configured to search a repository of goods or services offered, a repository of goods or services sought, and a repository of social relationships based on a search parameter and a level of degree of contact between a searcher and members of the repository of social relationships;
a matching module configured to perform autonomic n-way cross matching of repository content based on the level of degree of contact between users including cross-matching of lists of goods and services offered and goods and services desired where n is an integer equal to or greater than two; and
a notification module configured to present the results of the matching to a user.
